(19) United States
(12) Patent Application Publication
(10) Pub. No.: US 2016/0046500 A1
(43) Pub. Date: Feb. 18, 2016

(54) METHOD FOR RECYCLING SALT FROM A HIDE-CURING RACEWAY

(71) Applicant: BIRKO CORPORATION, Henderson, CO (US)

(72) Inventors: Terry L. MCANINCH, Westminster, CO (US); Ramsey W. JOHNSON, Fort Lupton, CO (US)

(21) Appl. No.: 14/462,302

(22) Filed: Aug. 18, 2014

(51) Int. Cl. C01D 3/14

(52) U.S. Cl. CPC C01D 3/14

(57) ABSTRACT

A method of recycling salt from a used brine solution for curing animal hides includes adjusting a pH level of the used brine solution to between about 6 and 12. The method includes introducing an oxidizing agent into the used brine solution in an amount to have a concentration between about 5 ppm and 600 ppm therein. The method includes allowing the oxidation of the used brine solution for a duration and removing solid organic materials from a surface of the used brine solution.

### FIELD

The present disclosure relates generally to methods for recycling salt from a hide raceway, including killing bacteria in and removing solid organic materials from a used brine expended from a hide-curing raceway prior to increasing the concentration of salt in the used brine.

### BACKGROUND

The profitability of a meat-packing plant is greatly affected by the money that the operator receives from various by-products of the meat-packing operation. Typically, the most profitable by-product is from the sale of hides for the production of leather. While the tanning operation in which the hide is turned into leather is usually conducted at another facility, it is essential for the meat-packer to preserve the value of the hide by curing the hide before shipment to the tanner. The hide must be as clean and free of bacteria as possible in order to avoid decomposition of the hide in the period between removal from the carcass and the tanning operation. That period may be as short as a few days or as long as a year or more. Decomposition occurs through the action of bacteria and enzymes, both of these processes being accelerated by heat and moisture. As used herein, references to the deleterious action of bacteria on hides generally refer to the action of both bacteria and enzymes. On a hot summer day, decomposition can be visually observed within four hours of slaughtering and hide removal. Since uncured hides typically contain approximately two thirds water by weight, the meat-packer should insure that the cured hides are as saturated with salt as possible. This minimizes possible deterioration and reduces the chances of claims by the tanner for insufficient cure.

Perhaps the most significant goal of hide-curing at the meat-packing plant is to reduce the damage that bacteria and other microorganisms can cause to the hide tissue between the time that the hide is flayed from the carcass and the time that it is tanned into leather. Typically the green hide contains contaminants that were present on the animal when it entered the meat-packing facility, including fresh and decomposed manure and organic matter, such as blood, that are released from the animal during the initial stages of the slaughtering process. All of these organic materials are ideal nutrients for destructive bacteria. If the growth of bacteria is not halted by the curing process, the hide can decompose into a useless, glue-like mass prior to tanning.

The problem of inhibiting microbial growth involves a number of considerations. Typically, growth of microbial contaminants is inhibited chemically. In addition, it is beneficial, and in some instances, critical, to physically remove from the hide the organic material which is an ideal food source for microbes. As mentioned previously, the organic material includes manure, blood and other organic contaminants released in the slaughtering process as well as a not insignificant amount of fat attached to the hide itself. If organic material is not physically removed from the hide, any microbes that survive the treatment can propagate in the remaining organic material before tanning is commenced.

Presently, meat-packing plants in the United States typically treat green hides in a series of processing steps. Although the exact nature and order of steps may vary depending on the size and age of a plant, the many plants typically treat a hide in the following manner.

When a hide is removed from an animal, it contains manure and other dirt on one side and a layer of animal fat, which may be as thick as one-half to three-quarters of an inch, on the other. In the presence of these contaminants and with the residual body heat from the animal, bacterial decomposition of the hide will begin immediately. Accordingly, the removed hide is promptly immersed in cold water both to cool the hide and to remove at least some of the contaminants by washing.

Washed hide may be processed in a fleshing machine. Such a device contains bars or knives which are drawn against both sides of the hide to remove excess fat on one side and manure and other physical, organic contaminants on the other. In many instances, however, the hide is not processed in a fleshing machine, and the cool, washed hide is sent immediately to a hide-curing raceway.

Regardless of whether the hide has been fleshed or not, the hide sent to the raceway still contains a layer of fat and organic material, as well as bacteria. The purpose of the hide-curing raceway is to inhibit bacteria growth and prevent enzymatic chemical decomposition of the hides.

A typical hide raceway is an oval shaped structure filled with brine. These structures are often large, containing tens of thousands of gallons of brine and hundreds of hides. Paddle wheels placed on each side of the raceway circulate the hides in the brine to maximize contact between the hides and the brine and the removal of contaminants. The brine is a saturated aqueous solution of salt, i.e., sodium chloride. Treatment is normally affected for 16 to 72 hours, although the most typical time is about 18 hours. The salt inhibits bacteria growth and is effective at preventing bacteria multiplying on the hides. In addition, the salt replaces a significant portion of the water in the hides. As much as two (2) gallons of water is released from each hide. Excess brine is permitted to overflow the raceway. The operator of the curing raceway must monitor the salinity of the raceway brine carefully to ensure that the brine remains saturated. If the brine does not remain saturated, the hides will not be saturated with salt and may decompose later.

Because of the foregoing qualities and the fact that it is relatively inexpensive, salt is the primary curing agent. Other hide preservatives and cure accelerators are sometimes added to the brine, but the principal agent is salt.

The cured hides are removed from the brine and are then pulled and treated in a wringer or by other means to reduce moisture. They are then graded, folded, bundled and palletized for shipment.

The brine treatment is the essential step common to hide-curing processes at meat-packing plants in the United States. Although the process has been utilized since the 1950's, significant problems persist. Increasing environmental concerns significantly limit the disposal of the salt-containing brine. Typically, a raceway is restocked with plain salt to maintain the salinity of the raceway brine at saturation, while the overflowing brine is disposed of. However, in many states, excess fees are charged for disposal of raceway effluent exceeding a threshold concentration of sodium. As each hide produces as much as two (2) gallons of water, a high-capacity raceway may incur significant costs for disposing the overflowing brine. Two (2) gallons of overflown brine may contain as much as about five (5) lbs. salt, which can include two (2) lbs. sodium. As a result, operators of meat-packing plants find it increasingly difficult to dispose of existing brine.

### BRIEF SUMMARY

In some embodiments, a method of recycling salt from a used brine solution for curing animal hides comprises adjusting a pH level of the used brine solution to a pH between about 6 and 12 and introducing a peracid into the used brine solution in an amount to have a concentration between about 5 ppm and 600 ppm and allowing the peracid to react with the used brine solution for a duration. The method also includes removing solid organic materials from a surface of the used brine solution.

In other embodiments, a method of rejuvenating a used brine solution utilized in curing animal hides comprises adding a pH controlling agent to the used brine solution causing the pH level of the used brine solution to be between about 6 and 12 and adding at least one oxidizing agent to the used brine solution. The method includes removing a layer of concentrated solid organic materials from the used brine solution.

In other embodiments, a method of rejuvenating, in a first container, a used brine solution utilized in curing animal hides comprises adding sodium hydroxide to the used brine solution causing the pH level of the used brine solution to be between about 8 and 12 and adding at least one peracid to the used brine solution in an amount to have a concentration between about 5 ppm and 600 ppm. The method includes removing a layer of concentrated solid organic materials from the used brine solution.

### BRIEF DESCRIPTION OF THE DRAWINGS

While the disclosure concludes with claims particularly pointing out and distinctly claiming specific embodiments, various features and advantages of embodiments of the disclosure may be more readily ascertained from the following description when read in conjunction with the accompanying drawings, in which:

FIG. 1 illustrates a schematic diagram illustrating a process for recycling salt from a hide-curing raceway, according to an embodiment of the present disclosure.

FIG. 2 illustrates a schematic diagram illustrating a process for recycling salt from a hide-curing raceway, according to an additional embodiment of the present disclosure.

### DETAILED DESCRIPTION

The illustrations presented herein are not meant to be actual views of any particular raceway, tank, skimmer, device or component thereof, but are merely idealized representations employed to describe illustrative embodiments. Thus, the drawings are not necessarily to scale.

The cited reference(s) herein, regardless of how characterized, are not admitted as prior art relative to the disclosure of the subject matter claimed herein.

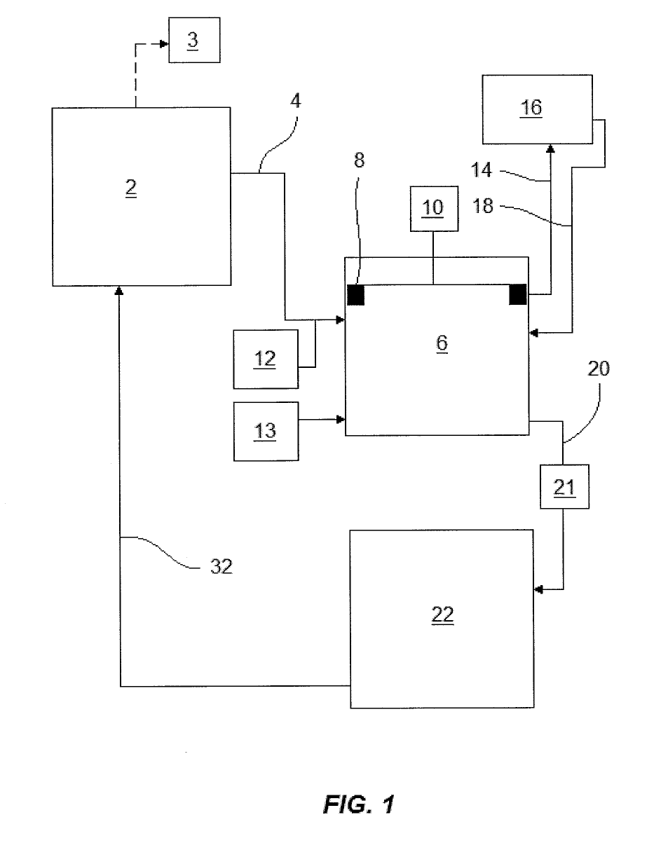

The methods, components and embodiments described herein allow for effective management of excess brine solution created by water pulled from hides during the curing process, and further allow for recovery of salt from the excess brine for reintroduction into the raceway. FIG. 1 illustrates a schematic diagram illustrating an embodiment of a process of the present disclosure. A container 2 for curing hides, also referred to as a “hide-curing raceway,” may contain a brine solution comprising an aqueous salt solution for inhibiting bacteria growth. The hide-curing raceway 2 may be sized to contain tens of thousands of gallons of brine and hundreds of hides; however, the hide-curing raceway 2 may be sized to accommodate a larger or smaller number of hides. As the hides are cured, the content of organic materials, such as bacteria, blood, fat, hair and manure, in the brine increases. Additionally, each hide may release as much as (2) gallons of water into the brine, thereby diluting the salt concentration of the brine. A user may monitor the salt concentration, or “salinity,” of the brine in the raceway 2 by taking samples and measuring the samples with a salometer 3. In a hide-curing operation, an operator may measure the salinity of a brine sample taken from the raceway 2 before a first group of hides are removed from the raceway 2. The salinity of a second brine sample may be measured after the first group of hides are removed and before a second group of hides are introduced into the raceway 2. The salinity of a third brine sample may be measured about eight (8) hours after the second group of hides is introduced into the raceway 2. In other embodiments, the salinity of more or fewer than three (3) brine samples may be measured. Brine volume gained from the curing process is eliminated as waste-water. Salt in the used brine solution is a significant contributor to the amount of sodium in the waste-water of a meat-packing plant. High sodium levels in waste-water, in many instances, increase the cost of disposing of such waste-water. Additionally, used brine solution is typically not reused for curing hides because of its high organic content, which would increase, or “build up,” if reintroduced into the raceway 2, causing deterioration of the hides or, at a minimum, reducing the ability of the brining system to cure the hides. Therefore, a process is implemented to recycle salt from the used brine solution, including reducing the organic content of the used brine solution and reintroducing the recovered salt into the hide-curing raceway 2 to maintain the salinity of the brine at its saturation point-26.4 wt. %.

Used brine solution may be transferred from the hide-curing raceway 2 through a line 4 to a secondary tank 6. The used brine solution may undergo an antimicrobial treatment in the secondary tank 6 to remove organic content, including proteolytic and other bacterial content, therefrom. The antimicrobial treatment may be similar to those disclosed in U.S. Pat. No. 5,435,808, issued Jul. 25, 1995, to Holzhauer et al.; U.S. Pat. No. 5,472,619, issued Dec. 5, 1995, to Holzhauer et al.; and U.S. Pat. No. 5,647,997, issued Jul. 15, 2007, to Holzhauer et al., the disclosure of each of which is incorporated herein in its entirety by this reference. The secondary tank 6 may include a skimmer 8 powered by a motor 10 for removing surface materials from the used brine solution, as discussed in more detail below. The secondary tank 6 may be in communication with a supply 12 of an agent for adjusting and/or regulating the pH level of the used brine solution in the secondary tank 6. The pH level of the used brine solution may vary depending on a number of factors, including, by way of non-limiting example, soil present on the hides prior to their introduction into the raceway 2. The pH regulating agent may be, by way of non-limiting example, an alkali metal hydroxide, such as sodium hydroxide or potassium hydroxide, or may be a carbonate, a phosphate or a silicate, such as a metasilicate or sodium silicate. The pH regulating agent may be dispensed from the supply 12 into the secondary tank 6 in an amount to adjust the pH level of the used brine solution to a pH level between about 6 and 12. Additionally, increasing the pH level of the brine to such levels enhances removal of solid organic materials, as flocculation of these organic materials tends to increase with increasing pH of the brine.

Once the pH level of the used brine solution in the secondary tank 6 has been adjusted to a pH level between about 6 and 12, a composition for killing bacteria and aerating the use brine solution may be added to the secondary tank 6 from a supply 13. The composition may contain a peracid. The peracid may be added to the secondary tank 6 until the concentration of the peracid in the used brine solution in the secondary tank 6 is about 5 ppm to about 500 ppm. The peracid may be peracetic acid or, by way of non-limiting example, perlactic acid, percitric acid, perpropionic acid, perbenzoic acid, perpentenoic acid, perbutyric acid, or a combination thereof. Peracetic acid has microbicidal properties and attacks microorganisms quickly. In commercially available forms, peracids, such as peracetic acid, contain hydrogen peroxide, as well as one or more stabilizers—such as phosphonic acid derivatives, picolinic acid, or other sequestering agents that tightly bind trace metals to prevent decomposition, or “offgassing,” of the peracid due to trace catalytic metal ions from such metals—to extend the shelf life of the peracid. The peracid composition has many functions in relation to the used brine solution. The peracid oxidizes solid organic materials, such as blood, fat, hair and manure, in the used brine solution, causing these solid organic materials to float to the surface where they can be removed from the secondary tank 6 by the skimmer 8. The peracid also assists in flocculating the solid organic materials, further facilitating their removal from the used brine solution. In additional embodiments, the composition may contain hydrogen peroxide without any peracid. In such embodiments, the hydrogen proxide may have a concentration in the used brine solution of about 1.0 wt. % or less. In yet additional embodiments, the composition may contain a peracid and additional hydrogen peroxide added separately to the brine or, alternatively, added as a single mixture. The hydrogen peroxide is also a flocculant and an oxidizer, wherein the release of oxygen during the oxidation process further aerates the brine and lifts solid organic materials to the surface. In embodiments where the composition includes a peracid, after the peracid has been introduced into the used brine solution in the secondary tank 6, the mixture may reside in the secondary tank 6 for a sufficient duration to allow the peracid to oxidize the brine and break the emulsion between the brine and the solid organic materials therein, causing the solid organic materials to float to the surface. By way of non-limiting example, the peracid may remain in the used brine solution in the secondary tank 6 for less than one (1) hour. However, shorter or longer durations are possible, and may depend upon the particular concentrations of the peracid in the used brine solution, the particular peracid used, and the organic content levels in the used brine solution prior to application of the composition.

It is to be appreciated that the pH regulating agent and the composition may be added to the used brine solution continuously at separate locations of the process. For example, as shown in FIG. 1, the pH regulating agent may be introduced into the brine in line 4 prior to entering the secondary tank 6 and the composition may be introduced directly into the secondary tank 6. In other embodiments, the composition may be introduced into the line 4 downstream of the pH regulating agent. In yet other embodiments, the pH regulating agent and the composition may be introduced into the brine together as a single mixture, either into line 4 upstream of the secondary tank 6 or directly into the secondary tank 6.

To further assist in aeration of the used brine solution and lifting the solid organic materials to the surface, the secondary tank 6 may include one or more mechanical aerators to increase the oxygen saturation of the water. By way of non-limiting example, the secondary tank 6 may include surface aerators, such as floating surface aerators and paddlewheel aerators, as well as sub-surface aerators, such as diffusors, jet aerators, course bubble aerators and fine bubble aerators. In other embodiments, the secondary tank 6 may be a diffused air flotation (DAF) tank.

It is also to be appreciated that any manner of removing the solid organic materials from the used brine solution is within the scope of the embodiments disclosed herein. By way of non-limiting example, instead of a skimmer, the layer of solid organic materials may be separated from the used brine solution by expelling the used brine solution through an outlet located at a bottom of the secondary tank 6, effectively removing the used brine solution from the secondary tank 6 while leaving the layer of solid organic materials in the secondary tank 6. In such embodiments, the remaining solid organic materials may be subsequently rinsed and removed from the secondary tank 6.

With continued reference to FIG. 1, solid organic materials removed by the skimmer 8 may optionally be transferred from the secondary tank 6 through a line 14 to a tote 16 adapted for separating residual brine from the skimmed solid organic materials. After residual brine is separated from the solid organic materials in the tote 16, the separated brine may be transferred back to the secondary tank 6 through a return line 18.

After the used brine solution in the secondary tank 6 has been exposed to the peracid for a sufficient time to allow the peracid to aerate the brine and allow the solid organic materials to be skimmed from the surface of the brine, the remaining brine may be transferred through a line 20 to a heating element 21 that heats the brine to a temperature as high as about 250° F. The heated brine water may be allowed to evaporate until the resulting brine solution essentially becomes a salt slurry having a salinity of 40-95 wt. %. The slurry may be conveyed to a third tank 22 for storage. In some embodiments, the water may be allowed to evaporate from the brine until the brine becomes a slurry having a salinity of 40-70 wt. %. In yet other embodiments, the water may be allowed to evaporate from the brine until the brine becomes a slurry having a salinity of 80-95 wt. %. In further embodiments, as described more fully below, the water may be allowed to evaporate from the brine until the salt therein become substantially completely dehydrated (i.e., the salt concentration increases to 100 wt. %).

For optimal hide curing, the salinity of the brine in the raceway 2 must remain at or near the saturation point of salt in the brine, as previously described. To accomplish this, a conveyer 32, such as an auger or a conveyor belt, may convey a constant supply of the salt slurry from the third tank 22 to the raceway 2. If the salinity of the slurry in the third tank 22 is low enough, the conveyor 32 may be a pump. However, a pump may be impractical if the salinity of the slurry is too high. The rate at which the slurry is conveyed to the raceway 2 may be determined by the salinity of the brine in the raceway and the salinity of the slurry in the third tank 22. The conveyance rate of the salt slurry may be manually adjusted by a system operator. In other embodiments, the delivery rate of salt slurry to the raceway 2 may be automated. For example, in such embodiments, an electronic controller (not shown), including a processor, may automatically adjust the slurry deliver rate as determined by input parameters, such as the salinity of the brine in the raceway and the salinity of the slurry in the third tank 22. In additional embodiments, such as when the salt is completely dehydrated, the salt may be disposed in a container and transported to the hide-curing raceway 2 by a forklift or other conveying device. The dehydrated salt may then be reintroduced into the raceway 2 until the salt content of the brine reaches saturation.

In larger plants, the water evaporated from the used brine solution (i.e., “waste-water”) may be transported to a rendering facility (not shown). The rendering facility may include a condenser for condensing the evaporated waste-water, which waste-water may also pass through a heat exchanger for heating other elements and/or facilities of the meat-packing plant. Subsequently, the treated waste-water may be discarded to sewage, to one or more lagoons, or directly to the environment if the content of contaminants therein falls below required levels.

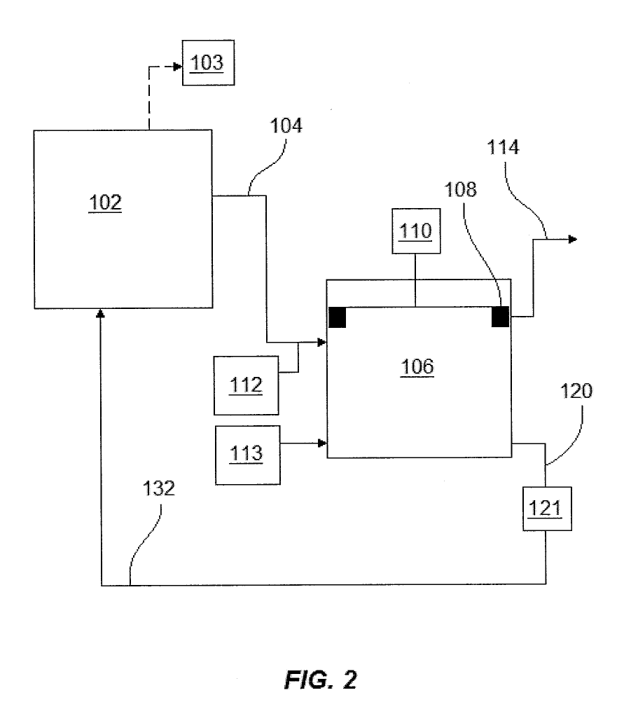

FIG. 2 illustrates a schematic diagram illustrating an additional embodiment of a process for recycling salt from a hide-curing raceway. As with the embodiment illustrated in FIG. 1, a hide-curing raceway 102 may contain a brine solution comprising an aqueous salt solution for inhibiting bacteria growth. A user may monitor the salinity of the brine in the raceway 102 by measuring samples with a salometer 103. Used brine solution may be transferred from the hide-curing raceway 102 through a line 104 to a secondary tank 106. The secondary tank 106 may include a skimmer 108 powered by a motor 110 for removing surface materials from the used brine solution. The secondary tank 106 may be in communication with a supply 112 of an agent for adjusting and/or regulating the pH level of the used brine solution in the secondary tank 106. The pH regulating agent may be an alkali metal hydroxide, such as sodium hydroxide or potassium hydroxide, or may be a carbonate, a phosphate or a silicate, as previously described. The pH regulating agent may be dispensed from the supply 112 into line 104 in an amount to adjust the pH level of the used brine solution in the secondary tank to a pH level between about 6 and 12.

Once the pH level of the used brine solution in the secondary tank 106 has been adjusted to a pH level between about 6 and 12, a composition for killing bacteria and aerating the use brine solution is added to the secondary tank 106 from a supply 113. As previously described, the composition may contain a peracid. The peracid may be added to the secondary tank 106 at a concentration of about 5 ppm to about 600 ppm in the used brine solution. After the peracid has been introduced into the used brine solution in the secondary tank 106, the mixture may reside therein for a sufficient duration to allow the peracid to oxidize the brine and break the emulsion between the brine and the solid organic materials therein, causing the solid organic materials therein to float to the surface, from which the solid organic materials may be removed by the skimmer 108, as previously described. In additional embodiments, the composition may contain hydrogen peroxide without any peracid. In such embodiments, the hydrogen proxide may have a concentration in the used brine solution of about 1.0 wt. % or less. In yet additional embodiments, the composition may contain a peracid and additional hydrogen peroxide added separately to the brine or, alternatively, added as a single mixture.

To further assist in aeration of the used brine solution and lifting the solid organic materials to the surface, the secondary tank 106 may include one or more aerators to increase the oxygen saturation of the water, as previously described. In other embodiments, the secondary tank 106 may be a diffused air flotation (DAF) tank.

Solid organic materials removed by the skimmer 108 may be transferred from the secondary tank 106 through a waste line 114 for subsequent disposal or further processing. After the solid organic materials have been skimmed from the secondary tank 106, the remaining brine may be transferred through a line 120 to a heating element 121. The heating element 121 may heat the brine to a temperature as high as about 250° F. The heated brine water may be allowed to evaporate until the resulting brine solution essentially becomes a slurry having a salinity in the range of 40-95 wt. %, as previously described. In further embodiments, the water may be allowed to evaporate from the brine until the salt therein becomes substantially completely dehydrated (i.e., the salt concentration increases to 100 wt. %).

A conveyor 132, such as an auger or a conveyor belt, may convey a constant supply of the salt slurry to the raceway 102. As previously described, if the salinity of the slurry is low enough, the conveyor 132 may be a pump 130. In other embodiments, such as embodiments where water is evaporated from the brine until the salt therein becomes completely dehydrated, the dehydrated salt may be disposed in a container and transported to the hide-curing raceway 102 by a forklift or other conveying device, as previously described. The dehydrated salt may then be reintroduced into the raceway 102 until the salt content of the brine reaches saturation.

The various embodiments of the salt recycling systems and processes described herein may include many other features not shown in FIGS. 1 and 2 or described in relation thereto, as some aspects of the system may have been omitted for clarity and ease of understanding. Therefore, it is to be understood that the systems and processes for recycling salt include many features in addition to those shown in the figures. Furthermore, it is to be further understood that the systems and processes may not contain all of the features herein described.

### Example 1

The following agents were used in a laboratory experiment to test the reduction of bacteria levels in a used, untreated brine solution extracted from a hide raceway with a full complement of fleshed hides:
sodium hydroxide was added to the brine to adjust the pH of the brine upward to a range between 11-12;
peracetic acid was introduced into the brine until the concentration of peracetic acid in the brine was about 500 ppm; and
hydrogen peroxide, present in the perecetic acid prior to introduction of the peracetic acid into the brine, had a concentration in the brine less than about 0.1 wt. %.
   The experiment involved a number of tests performed on four separate days. The results of each day's tests were averaged to produce four separate aggregated test results. The pH level, proteolytic bacteria content (measured in colony-forming unit per milliliter (CFU/ml)), aerobic bacteria content (measured in CFU/ml) and organic content (measured in wt. %) of the used brine solution were measured before the composition was added thereto. Subsequently, the sodium hydroxide was added until the pH level of the used brine solution was increased to a range between 11 and 12. The peracetic acid, with hydrogen peroxide therein, was then added to the used brine solution resulting in concentrations of 500 ppm peracetic acid and <0.1 wt. % hydrogen peroxide in the used brine solution. The peracetic acid and hydrogen peroxide were allowed to treat the used brine solution for approximately one (1) hour. Then, the pH level, bacteria levels and organic content of the used brine solution were measured. The tests revealed the following:

| | | | Proteolytic | Total Aerobic | Organic |
|---|---|---|---|---|---|
| | | | Bacteria | Bacteria | Content |
| Test | | pH | (CFU/ml) | (CFU/ml) | (wt. %) |
| 1 | Pre-treatment | 6.7 | 1,000 | 28,000 | 0.8 |
| | Post-treatment | 10.4 | <1 | 2,000 | 0.5 |
| 2 | Pre-treatment | 7.3 | 1,367 | 59,000 | 0.8 |
| | Post-treatment | 11.7 | <1 | 1,667 | 0.6 |
| 3 | Pre-treatment | 6.0 | 4,133 | 55,333 | 0.9 |
| | Post-treatment | 10.9 | <1 | <1 | 0.4 |
| 4 | Pre-treatment | 7.2 | 7,400 | 18,667 | 0.9 |
| | Post-treatment | 11.1 | <1 | 1,000 | 0.3 |

These results indicate a minimum proteolytic bacteria kill rate above 99.9% and a maximum proteolytic bacteria kill rate higher than 99.98%. The results also indicate a minimum total aerobic bacteria kill rate above 92.9% and a maximum aerobic bacteria kill rate higher than 99.9992%.

While certain illustrative embodiments have been described and depicted in the figures, those of ordinary skill in the art will recognize and appreciate that the scope of this disclosure is not limited to those embodiments explicitly shown and described herein. Rather, many additions, deletions, and modifications to the embodiments described herein may be made to produce embodiments within the scope of this disclosure, such as those hereinafter claimed, including legal equivalents. In addition, features from one disclosed embodiment may be combined with features of another disclosed embodiment while still being within the scope of this disclosure, as contemplated by the inventors.

What is claimed is:

1. A method of recycling salt from a used brine solution for curing animal hides, comprising:
adjusting a pH level of the used brine solution to a pH between about 6 and 12;
introducing a peracid into the used brine solution in an amount to have a concentration between about 5 ppm and 600 ppm;
allowing the peracid to react with the used brine solution; and
removing solid organic materials from a surface of the used brine solution.

2. The method of claim 1, further comprising transferring the used brine solution from a first container for curing animal hides to a secondary container prior to adjusting the pH level of the used brine solution.

3. The method of claim 2, further comprising:
transferring the used brine solution from the secondary container and through a heating element;
evaporating water from the used brine solution until at least some of the used brine solution forms a slurry having a salt concentration greater than about 70 wt. %; and
transferring the slurry to the first container for curing animal hides.

4. The method of claim 3, further comprising transferring the slurry to a third container after evaporating water from the used brine solution and prior to transferring the slurry to a container for curing animal hides.

5. The method of claim 3, wherein transferring the slurry to the first container for curing animal hides comprises transferring the slurry via one or more of an auger, a conveyor belt, and a forklift to the first container for curing animal hides.

6. The method of claim 1, wherein adjusting the pH level of the used brine solution to a pH between about 6 and 12 comprises introducing one or more of sodium hydroxide, potassium hydroxide, a carbonate, a phosphate and a silicate to the used brine solution.

7. A method of rejuvenating a used brine solution utilized in curing animal hides, comprising:
adding a pH controlling agent to the used brine solution causing the pH level of the used brine solution to be between about 6 and 12;
adding at least one oxidizing agent to the used brine solution; and
removing a layer of concentrated solid organic materials from the used brine solution.

8. The method of claim 7, wherein the oxidizing agent comprises at least one peracid.

9. The method of claim 8, wherein the at least one peracid comprises at least one of peracetic acid, perlactic acid, percitric acid, perpropionic acid, perbenzoic acid, perpentenoic acid and perbutyric acid.

10. The method of claim 7, further comprising evaporating water from the used brine solution after removing the layer of concentrated solid organic materials therefrom.

11. The method of claim 10, wherein evaporating water from the used brine solution further comprises heating the used brine solution with a heating element.

12. The method of claim 10, wherein evaporating water from the used brine solution comprises evaporating water until the used brine solution forms a slurry having a salt concentration greater than about 70 wt. %.

13. The method of claim 12, further comprising transferring a substantially constant supply of the slurry to a container for curing animal hides to maintain a salt concentration of a brine solution in the container for curing animal hides at at least about 26 wt. %.

14. The method of claim 7, wherein the pH controlling agent comprises one of sodium hydroxide, potassium hydroxide, a carbonate, a phosphate and a silicate.

15. The method of claim 7, further comprising mechanically aerating the used brine solution.

16. The method of claim 7, wherein adding the pH controlling agent and the at least one oxidizing agent to the used brine solution comprises adding the pH controlling agent and the at least one oxidizing agent to the used brine solution in a dissolved air flotation (DAF) container.

17. The method of claim 7, wherein the at least one oxidizing agent consists essentially of hydrogen peroxide.

18. A method of rejuvenating, in a first container, a used brine solution utilized in curing animal hides, comprising:
adding sodium hydroxide to the used brine solution causing the pH level of the used brine solution to be between about 8 and 12;
adding at least one peracid to the used brine solution in an amount to have a concentration between about 5 ppm and 600 ppm; and
removing a layer of concentrated solid organic materials from the used brine solution.

19. The method of claim 18, wherein removing the layer of concentrated solid organic materials from the used brine solution comprises skimming the layer of concentrated solid organic materials with a motorized skimmer disposed in the first container.

20. The method of claim 18, wherein removing the layer of concentrated solid organic materials from the used brine solution comprises removing the used brine solution from the first container and leaving the layer of concentrated solid organic materials in the first container.

21. The method of claim 18, wherein:
the method further comprises evaporating water from the used brine solution until salt in the used brine solution is substantially completely dehydrated after removing the layer of concentrated solid organic materials from the used brine solution; and
transferring salt from the used brine solution to a second container for curing animal hides comprises transferring the substantially completely dehydrated salt from the used brine solution to the container for curing animal hides.
